(19) United States
(12) Patent Application Publication
(10) Pub. No.: US 2017/0190063 A1
(43) Pub. Date: Jul. 6, 2017

(54) CUTTING HEAD AND HAIR CUTTING APPLIANCE

(71) Applicant: KONINKLIJKE PHILIPS N.V., Eindhoven (NL)

(72) Inventors: BERNHARD SCHRATTER, EINDHOVEN (NL); MICHAEL JANNY, EINDHOVEN (NL); WOLFGANG JOHANNES OBERMANN, EINDHOVEN (NL)

(21) Appl. No.: 15/030,443

(22) PCT Filed: Sep. 15, 2015
(86) PCT No.: PCT/EP2015/071094

§ 371 Date: Apr. 19, 2016

(30) Foreign Application Priority Data
Sep. 18, 2014 (EP) 14185435.6

(51) Int. Cl. B26B 19/42; B26B 19/38; B26B 19/06

(52) U.S. Cl. CPC B26B 19/42; B26B 19/06; B26B 19/3846

(57) ABSTRACT

The present disclosure relates to a hair cutting appliance (10), particularly an electrically operated body grooming appliance (10), and to a cutting head (18) for a hair cutting appliance (10), the cutting head (18) comprising a blade set (20) comprising a stationary blade (36) and a cutter blade (38), the stationary blade (36) and the cutter blade (38) comprising at least one toothed leading edge (22, 24) jointly defined by respective teeth (62, 64) of the stationary blade (36) and the cutter blade (38), the teeth (62, 64) of the stationary blade (36) and the cutter blade (38) basically extending in a longitudinal direction (X), a skin protector (76) comprising a plurality of guide tabs (78) that are aligned with the teeth (62) of the stationary blade (36), wherein the stationary blade (36) further comprises a front face (58), particularly at the teeth (62) thereof, the front face (58) being arranged to face a user's skin, when in operation, wherein the cutter blade (38) is at least partially arranged at a rear face (60) of the stationary blade (36) facing away from the front face (58), particularly at the teeth (62) of the stationary blade (36), wherein the guide tabs (78) of the skin protector (76) are arranged adjacent to longitudinal tips (66) of the teeth (62) of the stationary blade (36) in a longitudinally displaced position, wherein the skin protector (76) defines a front face (92), and wherein the front face (92) of the skin protector (76) is at least partially rearwardly offset from the front face (58) of the stationary blade (36).

### FIELD OF THE INVENTION

The present invention relates to a cutting head for a hair cutting appliance, particularly an electrically operated body grooming appliance, the cutting head comprising a blade set including a stationary blade and a cutter blade, the stationary blade and the cutter blade comprising at least one toothed leading edge jointly defined by respective teeth of the stationary blade and the cutter blade, and wherein the cutter blade can be reciprocally moved with respect to the stationary blade to cut hair. The present disclosure further relates to a hair cutting appliance, particularly an electrically operated body grooming appliance, that is fitted with a respective cutting head.

### BACKGROUND OF THE INVENTION

Hair cutting appliances are generally known and may include hair trimmers, hair clippers and shavers. Electric hair cutting appliances may be powered by mains-supplied electricity and/or by batteries. Generally, hair cutting appliances are used to trim facial hair and head hair so as to allow a person to have a well-groomed appearance. To this end, single-purpose hair cutting appliances are well-known, for instance razors, shavers and hair clippers.

In this context, US 2014/0026422 A1 discloses a double-blade hair trimming device that comprises a blade body and a blade head. A driving device is arranged in the blade body. The blade head comprises a thick blade teeth edge and a thin blade teeth edge. Furthermore, the blade head comprises a fixed blade and a movable blade. The fixed blade and the movable blade are each provided with teeth sections at two opposite edges thereof. The movable blade moves reciprocally corresponding to the fixed blade to trim hair. The thick blade teeth edge shall be used for a rough hair cutting/trimming operations. The thin blade teeth edge shall be used for a fine trimming/cutting operations.

CH 206 252 A discloses a shaving head for a dry shaver, comprising an outer, stationary blade and an inner, movable blade, which cooperate to cut hairs, wherein the outer blade is connected with a protective comb, wherein the outer blade and the protective comb jointly define a tubular body, the outer blade and the protective comb comprising respective teeth, wherein a pitch of the teeth of the protective comb is the same as a pitch of the teeth of the stationary blade.

U.S. Pat. No. 2,262,388 A discloses a shaving head comprising a slotted stationary cutter, a movable cutter slidable in relation to said stationary cutter, a slotted guard member positioned on each side of said stationary cutter and the slots of said guard members being in registration with the slots of said stationary cutter, a spacer member positioned intermediate each guard member and the stationary cutter, and connecting elements each engaging said stationary cutter, said guard members and said spacer members and uniting them into a single unit.

However, in recent years an increased demand for so-called body groomers has been observed. Body groomers or body grooming appliances may be referred to as special purpose hair cutting appliances that may be used to remove, trim or cut body hair in body regions that do not include the neck, face or head of the user. In other words, body grooming appliances may also be referred to as total body hair cutting and/or trimming appliances. Body grooming appliances should be therefore particularly suited for hair cutting operations in the user's sensitive skin areas, for instance in genital areas (intimate hair cutting), in hard-to-reach areas, etc. Further applications for body grooming appliances may be leg shaving and/or underarm shaving.

While it is acknowledged that also shavers and/or head hair trimmers may be generally used for these applications, it has been observed that for several reasons many users prefer to use distinct body grooming appliances for the above-mentioned body grooming applications. This may have, on the one hand, hygienic reasons and health reasons. Furthermore, it has been observed that the user's skin in several body regions is particularly sensitive to treatments with conventional shavers and/or trimmers. Therefore, using conventional out-of-the-shelf shaving and/or head hair cutting appliances may cause significant skin irritations in these sensitive areas.

It has been further observed that it may be challenging to correctly orientate and/or align a hair cutting appliance with respect to the to-be-treated skin region when the skin region is actually hard to reach for the user. Misalignment of a hair cutting appliance, particularly of a cutting head thereof, with respect to the skin may further cause skin irritations or even skin cuts.

Consequently, there is still room for improvement in total body grooming appliances.

### SUMMARY OF THE INVENTION

It is therefore an object of the present invention to provide a cutting head for a hair cutting appliance, particularly for an electrically operated body grooming appliance, which may address at least some of the above-mentioned drawbacks and issues. In particular, it is an object of the present disclosure to provide a cutting head that is particularly suited for total body grooming applications, more particularly for hair cutting and/or hair removal in sensitive skin areas. It would be further advantageous to provide for a cutting head that reduces the risk of skin irritations when cutting hair in sensitive skin areas. Preferably, the risk of skin injuries and/or even skin cuts can be significantly reduced. It is further preferred that the cutting head can be set up to particular total body grooming applications in a cost-effective manner without adversely affecting the general cutting performance. It is another object of the present disclosure to present a hair cutting appliance, particularly a body grooming appliance, that is fitted with a respective cutting head.

In a first aspect of the present disclosure a cutting head for a hair cutting appliance, particularly an electrically operated body grooming appliance, is presented, the cutting head comprising:

a blade set comprising a stationary blade and a cutter blade, the stationary blade and the cutter blade comprising at least one toothed leading edge jointly defined by respective teeth of the stationary blade and the cutter blade, the teeth of the stationary blade and the cutter blade basically extending in a longitudinal direction,

a skin protector comprising a plurality of guide tabs that are aligned with the teeth of the stationary blade,

wherein the stationary blade further comprises a front face, particularly at the teeth thereof, the front face being arranged to face a user's skin, when an operation,

wherein the cutter blade is at least partially arranged at a rear face of the stationary blade facing away from the front face, particularly at the teeth of the stationary blade,

wherein the cutter blade can be reciprocally moved with respect to the stationary blade to cut hair,

wherein the guide tabs of the skin protector are arranged adjacent to longitudinal tips of the teeth of the stationary blade in a longitudinally displaced position,

wherein the skin protector defines a front face, particularly at the guide tabs thereof, the front face being arranged to face a user's skin, when operation, and

wherein the front face of the skin protector is at least partially rearwardly offset from the front face of the stationary blade, and

wherein the skin protector comprises at least one snap-on element that is adapted to a corresponding mating portion of a housing region of the cutting head.

The above aspect is based on the insight that the guide tabs of the skin protector may act as “wave breakers” when the hair cutting appliance is moved along the skin in an attempt to cut and/or trim hair. This includes that the skin protector may actually contact the to-be-treated skin portion to prepare the skin for the following cutting operation. Typically, when a blade set is moved along the skin, so-called skin bulges may be formed that quite likely may come into contact with the cutting edges of the blade set. The more sensitive and soft the skin is, the higher may be the risk of skin bulging or skin doming. The arrangement of guide tabs of the skin protector may be therefore used to smoothen the skin so as to avoid the formation of the skin bulges and/or skin domes. Consequently, the risk of skin irritations may be significantly reduced.

Furthermore, the skin protector may act as a guide for the to-be-cut hair. Generally, the guide tabs of the skin protector may be regarded as longitudinal extensions of the teeth of the stationary blade. Since the guide tabs are aligned with the teeth of the stationary blade, respective slots or spaces between the guide tabs are also aligned with respective slots between the teeth of the stationary blade. Consequently, hairs can be guided to the stationary blade and cut in a scissor-like cutting operation upon reciprocating movement of the cutter blade with respect to the stationary blade.

As indicated above, the front face of the skin protector is at least partially rearwardly offset from the front face of the stationary blade. Consequently, the skin protector shall not be regarded as a conventional spacing attachment comb which is typically used to trim hair to a desired (residual) length. Even with the skin protector attached to the cutting head, it is still desired in many applications to remove or cut the hairs completely (preferred residual length 0.0 mm or almost 0.0 mm). Hence, the skin protector does not significantly affect the shaving performance of the cutting head since the front face of the skin protector that actually comes into contact with the to-be-prepared skin is rearwardly offset from the front face of the stationary blade which actually comes into contact with the skin during the cutting operation as such. In other words, the blade set, particularly the stationary blade thereof, at least slightly protrudes beyond the skin protector, particularly the front face thereof, towards the skin, when in operation.

A cutting head that is fitted with a respective skin protector is particularly suited for total body trimming and/or grooming operations. The cutting head can be used in sensitive skin areas such as genital areas, underarm areas, etc. The cutting head is particularly suited for intimate hair cutting, particularly intimate shaving, underarm shaving, leg shaving, etc. Generally, the cutting head that is fitted with the skin protector may be used in hard-to-reach skin areas that are barely accessible and/or visible for the user.

Generally, the front face of the skin protector and the front face of the stationary blade may be offset from each other in a parallel fashion. However, a strictly parallel offset is not necessarily required. It is acknowledged in this respect that in regard of manufacturing tolerances, required draft angles and further influencing factors at least slight angular deviations between the front face of the skin protector and front face of the stationary blade may occur. Furthermore, the front face of the skin protector and the front face of the stationary blade may be basically parallel to a plane that is defined by an overall longitudinal direction X and an overall lateral direction Z of a referential coordinate system X-Y-Z of the cutting head. However, this is not a necessary prerequisite. Furthermore, the front face of the skin protector and/or the front face of the stationary blade preferably comprise a substantially planar shape. However, this is not a necessary basic prerequisite.

For instance, again referring to draft angles, manufacturing issues, etc., at least one of the front face of the skin protector and the front face of the stationary blade may be at least partially or sectionally curved. However, each of the front face of the skin protector and the front face of the stationary blade may comprise at least a substantially planar shape that is substantially parallel to a plane defined by the longitudinal direction X and the lateral direction Z. The front face of the stationary blade may be at least slightly rearwardly inclined with respect to a plane defined by the longitudinal direction X and the lateral direction Z, at least at the teeth of the stationary blade. In addition, or in the alternative, at least partially at the guide tabs, the front face of the skin protector may be slightly rearwardly inclined with respect to a plane defined by the longitudinal direction X and the lateral direction Z.

The skin protector may be generally referred to as skin protecting guard. The skin protector may be arranged to smoothen, condition and/or level the to-be-groomed skin. The guide tabs of the skin protector may be generally referred to as guide teeth, guard ribs, etc.

It is worth noting in this connection that the skin protector in isolation may form a separate independent aspect of the present disclosure. The skin protector may be attached to a cutting head and provide the cutting head with improved skin protecting features. Consequently, a cutting head that is fitted with a respective skin protector is particularly suited for hair cutting and/or shaving operations in sensitive skin regions.

Thanks to the at least one snap-on element, the attachment and/or detachment of the skin protector can be further facilitated. It may be therefore further envisaged that the cutting head can be fitted with more than one skin protector, wherein respective skin protectors may differ in the number and shape of their guide tabs, for instance.

A body grooming appliance within the context of the present disclosure is preferably a device that does not implement a foil shaving section adjacent to the blade set that comprises the stationary blade and the cutter blade. In other words, conventional razors that implement a combination of a central trimming blade set and two adjacent foil shaving sections which are well suited for shaving facial hair are not well suited for body grooming, particularly total body grooming applications. Therefore, at least in connection with some embodiments, the body grooming appliance may be also referred to as non-foil-type or foil-less total body groomer.

In one embodiment, the skin protector comprises at least one row of guide tabs extending from a frame body, wherein the guide tabs of the row alternate with spacing slots arranged therebetween that are aligned with respective tooth spaces arranged between the teeth of the stationary blade. It is further preferred that the thickness of the guide tabs in the lateral direction Z is adapted to the thickness of the teeth in the lateral direction Z. Since the guide tabs are aligned with respective teeth, also the slots between the guide tabs and the slots between the teeth may be aligned with each other. Consequently, hairs may enter the spacing slots between the guide tabs and be guided to the spaces between the teeth of the stationary blade upon movement of the cutting head through body hair.

In another embodiment of the cutting head, the number of the teeth at the stationary blade is equal to or greater than the number of the guide tabs at the skin protector, wherein a ratio of the number of the teeth of the stationary blade to the number of the guide tabs at the skin protector is preferably an integer number. In other words, the ratio may be in whole numbers, for instance 1:1, 2:1, 3:1, 4:1, etc.

As a consequence, not necessarily each tooth of the stationary blade needs to be assigned to a respective tab of the skin protector. However, in each case each guide tab may be aligned with a respective tooth. If, for instance, the above ratio is 2:1, the spaces between the guide tabs of the skin protector may be assigned to and aligned with two spacing slots and a tooth arranged therebetween at the stationary blade.

In still another exemplary embodiment, the blade set is a dual sided blade set, wherein the stationary blade and the cutter blade define a first toothed leading edge and a second toothed leading edge that is facing away from the first leading edge, wherein the first toothed leading edge and the second toothed leading edge are longitudinally spaced from each other, and wherein the skin protector comprises a first arrangement of guide tabs associated with the first toothed leading edge and a second arrangement of guide tabs associated with the second toothed leading edge.

The dual-sided or double-sided arrangement may have the advantage that more body regions may be reached with the cutting head when the cutting head is attached to a hair cutting appliance that comprises a basically elongated but at least slightly curved housing. Furthermore, the user may push and drag the hair cutting appliance, wherein in any case a toothed leading edge of the two toothed leading edges may cut hair. Consequently, both the push phase and the drag phase of a stroke can be used for cutting hair, inactive runs can be reduced. The cutting performance can be thus increased.

It may be further preferred in this context that the teeth of the stationary blade at the first toothed leading and the teeth of the stationary blade at the second toothed leading edge are laterally offset from each other, wherein the first arrangement of guide tabs and the second arrangement of guide tabs are offset from each other in a similar fashion.

In other words, the cutting head, particularly the blade set thereof, more particularly the stationary blade, may be configured in a basically unsymmetrical fashion. At least a slight offset between the first toothed leading and second toothed leading edge in the lateral direction Z may be present. However, a respective “pitch” of the teeth of the first toothed leading and second toothed leading edge may be constant. By way of example, in the lateral direction Z, teeth of the first toothed leading of the stationary blade may be aligned with tooth spaces between teeth of the second toothed leading edge of the stationary blade. It is therefore essential that also the guide tabs of the skin protector are correspondingly adapted to match the position of the teeth at the first toothed leading and the second toothed leading edge.

In still another exemplary embodiment, the skin protector is arranged as an attachment skin protector that is releasably attachable to the cutting head, wherein the skin protector is preferably an integrally formed part made from resilient material, particularly from plastic material. By way of example, the stationary blade and the cutter blade may be at least partially formed from metal material, particularly from sheet metal material. Since the skin protector is not directly involved in the cutting operation, softer materials, such as plastic material may be utilized. This may have the further advantage that the thermal conductivity of the skin protector is relatively low. Consequently, heat which can be generated in the course of the cutting operation between the cutter blade and the stationary blade basically cannot considerably heat up the skin protector.

In another exemplary embodiment, a set of skin protectors is provided that are releasably attachable to the cutting head and that differ in the number and shape of their guide tabs.

In still another exemplary embodiment, the skin protector and the cutting head comprise at least one positioning element and at least one corresponding engagement element that are configured to define a mounting position of the skin protector at the cutting head such that reversed mounting of the skin protector can be prevented. This may be particularly beneficial when a blade set is utilized that comprises more than one toothed leading edge. Since a proper alignment of the guide tabs of the skin protector and the teeth of the stationary blade is important for the cutting performance and the avoidance of skin irritations, a failure-proof assembly of the skin protector is particularly beneficial. One of the at least one positioning element and the at least one corresponding engagement element may be associated with the skin protector and the other one may be associated with a housing region of the cutting head. In other words, mounting features may be present that ensure that a back-to-front mounting or attachment of the skin protector at the cutting head is basically impossible.

In still another beneficial embodiment, the blade set and a housing region of the cutting head comprise at least one positioning element and at least one corresponding engagement element that are configured to define a mounting position for the blade set at the cutting head such that reversed mounting of the blade set can be prevented.

In still another beneficial embodiment, the skin protector and the blade set comprise at least one positioning element and at least one corresponding engagement element that are configured to define a mounting position for the skin protector with respect to the blade set such that reversed mounting of the skin protector can be prevented.

Since in essence, both the blade set and the skin protector have to be correctly mounted to the cutting head, it has to be considered that both mating pairs, the skin protector and the cutting head as well as the skin protector and the blade set are attached in the desired orientation. The skin protector and the blade set may be properly aligned and/or mutually oriented in a direct or mediate fashion. In the final assembly state, the respective toothed leading edge and the row of guide tabs assigned thereto should assume the originally desired and defined position at the cutting head.

In still another embodiment of the cutting head, the guide tabs of the skin protector comprise a longitudinal extension lₜ, particularly at the front face of the skin protector, that is less than 5.0 mm (millimeters), preferably the longitudinal extension lₜ is about 3.0 mm. These values may positively influence the cutting performance and the skin protecting ability of the cutting head.

In still another embodiment, the front face of the skin protector is rearwardly offset from the front face of the stationary blade by an offset dimension lₒ in the range of about 0.0 mm to about 0.5 mm, preferably in the range of about 0.35 mm to about 0.5 mm. The above range may exclude the 0.0 mm value. As a consequence, the stationary blade may be at least slightly exposed beyond the front face of the skin protector. Consequently, the general cutting performance may be maintained while skin irritations may be further reduced.

In yet another exemplary embodiment of the cutting head, the guide tabs of the skin protector comprise an end tip at their longitudinal end, wherein the end tip connects the front face and a respective inclined end surface of the guide tabs, wherein an angle of inclination a (alpha) between the front face and the inclined end surface of the guide tabs is in the range of about 30° to 60° (degrees). Preferably, the angle of inclination a is in the range of about 40° to 50°. More preferably, the angle of inclination a is about 45°. Generally, the inclined end surface may be inwardly inclined. In other words, the overall longitudinal extension of the skin protector at the frontal portion thereof, may be larger than the overall longitudinal extension of the skin protector at a rear portion thereof. Generally, each of the guide tabs may be triangular or wedge-shaped. The row of the guide tabs at the skin protector may define a respective overall inclined end surface. Preferably, the end tips of the guide tabs are rounded. Furthermore, external edges of the skin protector, particularly of the guide tabs, that may contact the user's kin may be rounded.

In still another exemplary embodiment, the skin protector comprises a loop-like closed structure formed by a frame body, wherein the closed structure surrounds a blade opening, wherein the blade set is arranged in the mounted state in the blade opening, wherein the frame body comprises two opposite, substantially laterally and vertically extending base lugs at longitudinal ends and two opposite, substantially longitudinally and vertically extending side lugs at lateral ends, and wherein at least one of the base lugs or of the side lugs comprises a mounting alignment feature, particularly a recess or a protrusion. Preferably, the mounting alignment feature is not present at the opposite base lug or side lug. Consequently, misalignment of the skin protector in the course of the mounting operation may be avoided.

The above embodiment may be further developed in that the side lugs are coupled to basically U-shaped lateral bracket portions arranged adjacent to lateral ends of the blade set. The lateral bracket portions may be U-shaped than viewed in a plane parallel to the front face of the blade set. The base lugs may comprise a snap-on feature and include at least one engagement element for engaging a mating engagement element at a housing region of the cutting head. Alternatively, or in addition, the side lugs may comprise a snap-on feature and include at least one engagement element for engaging a mating engagement element at a housing region of the cutting head. Generally, the skin protector may have an overall appearance that is basically similar to an attachment comb. However, attachment combs typically space the blade set away from the skin to enable cutting hairs to a desired residual length. By contrast, the skin protector is shaped such that the blade set, particularly the stationary blade thereof, is at least slightly elevated with respect to the skin protector. Consequently, the skin protector basically does not influence the cutting length.

According to another aspect of the present disclosure, a hair cutting appliance, particularly an electrically operated body grooming appliance is presented, the hair cutting appliance comprising a cutting head and a skin protector in accordance with at least some embodiments as disclosed herein. Generally, the hair cutting appliance may be regarded as an electrically powered hair cutting appliance. Consequently, a motor may be provided for driving the blade set. Typically, the cutter blade which may also be referred to as movable cutter blade, is movable with respect to the stationary blade. The cutter blade may be driven with respect to the stationary blade, particularly in an oscillating or reciprocating fashion. Generally, the hair cutting appliance may comprise an elongated housing that may be at least slightly curved, the housing may further comprise a first end and a second end which is opposite to the first end. At the first end of the housing, the cutting head may be arranged to which the skin protector may be attached. The second end of the housing of the hair cutting appliance may be referred to as handle end. The hair cutting appliance may be referred to as total body trimmer.

### BRIEF DESCRIPTION OF THE DRAWINGS

These and other aspects of the invention will be apparent from and elucidated with reference to the embodiments described hereinafter. In the following drawings

FIG. 1 shows a schematic perspective view of an exemplary embodiment of an electric hair cutting appliance, particularly an electrically operated body grooming appliance;

FIG. 2 shows a perspective view of a blade set for a hair cutting appliance that can be driven by a drive mechanism;

FIG. 3 shows a longitudinal side view of the blade set in accordance with

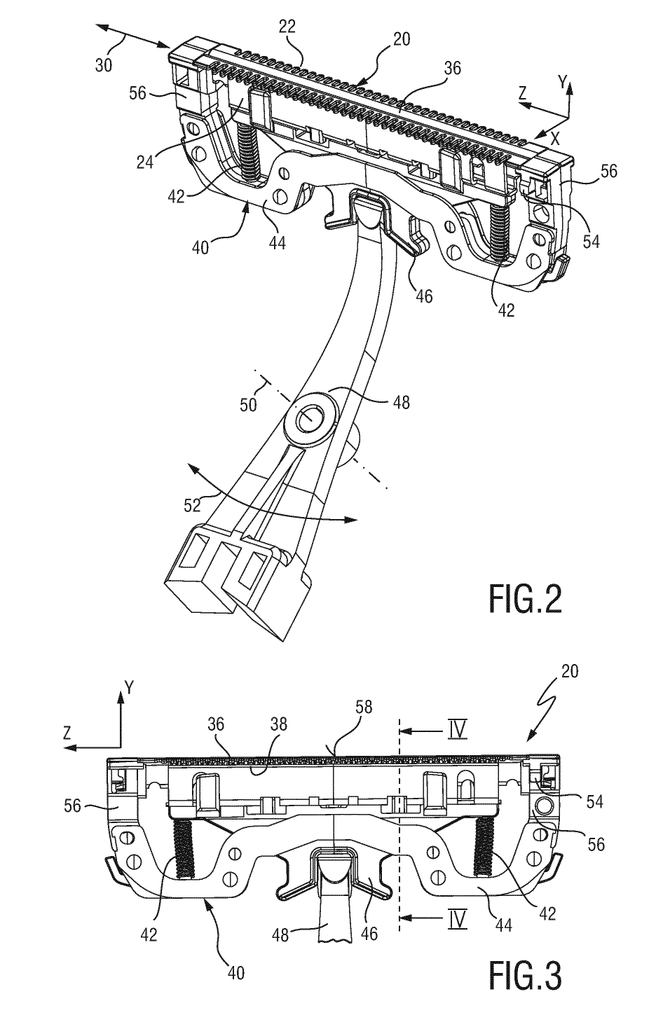

FIG. 2;

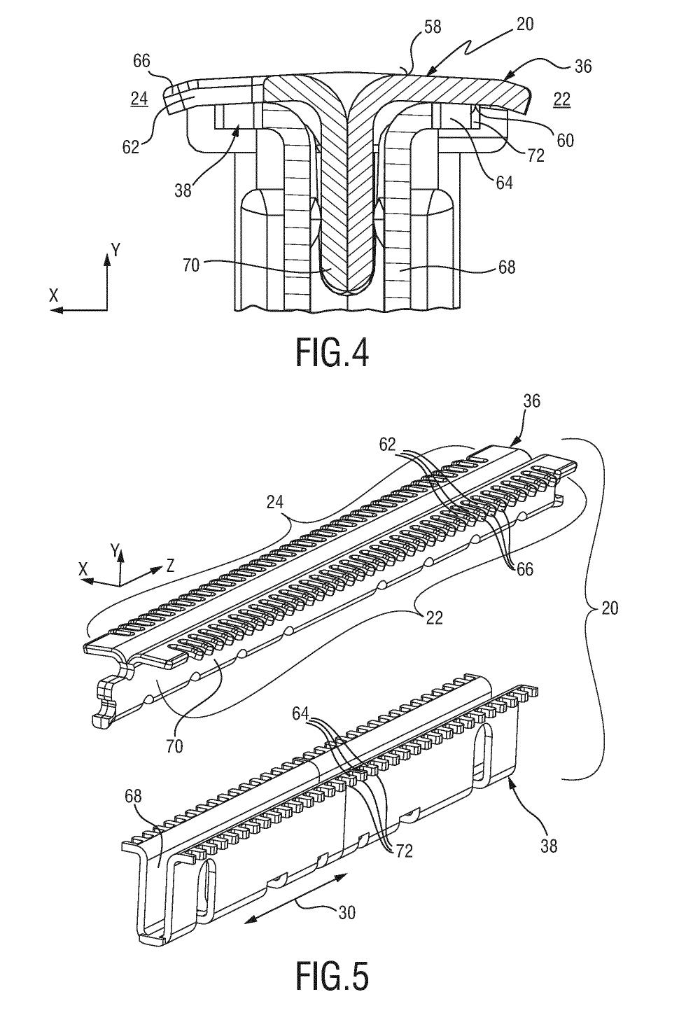

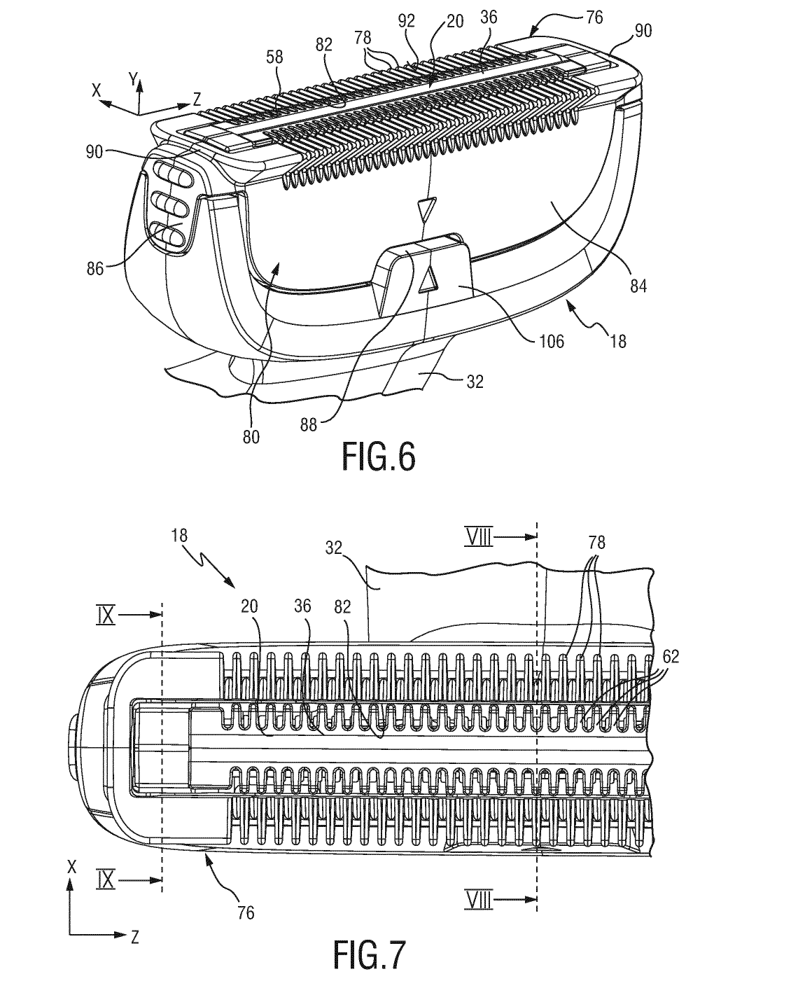

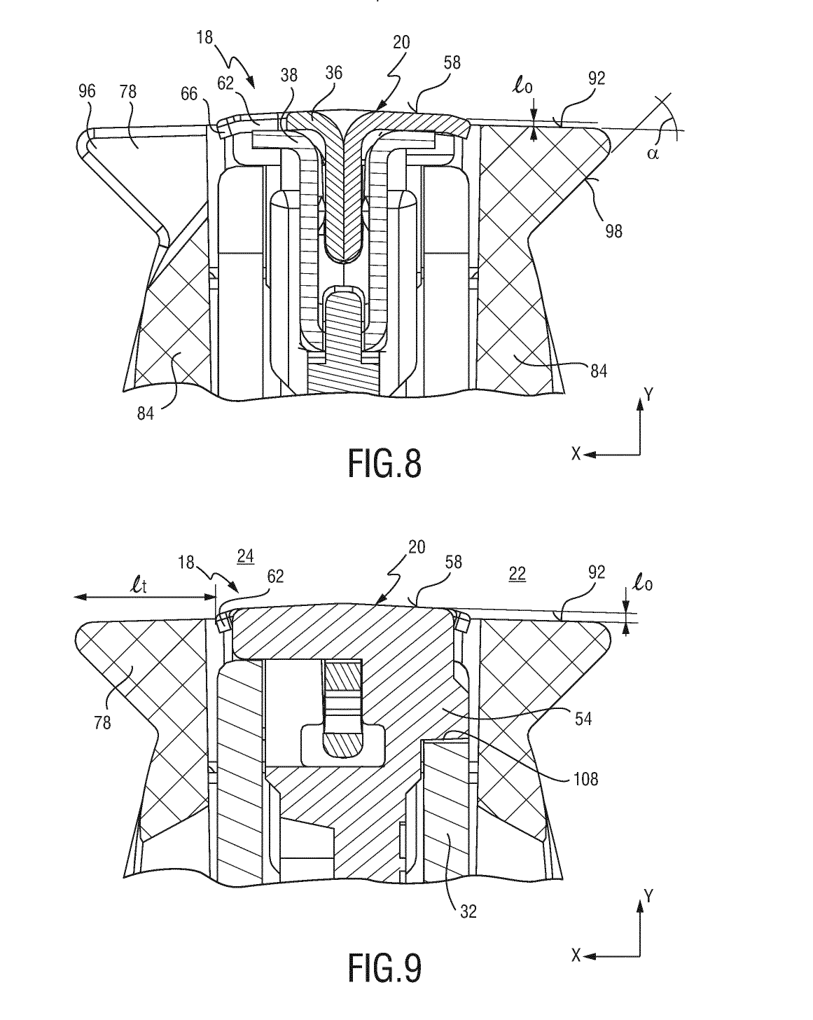

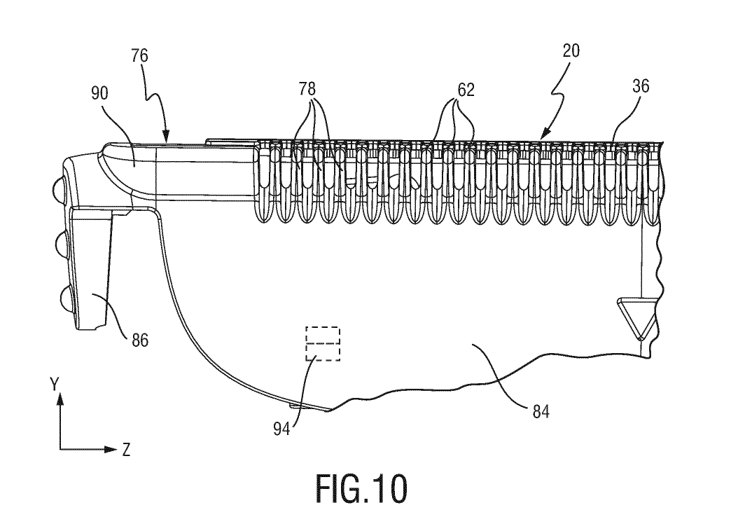

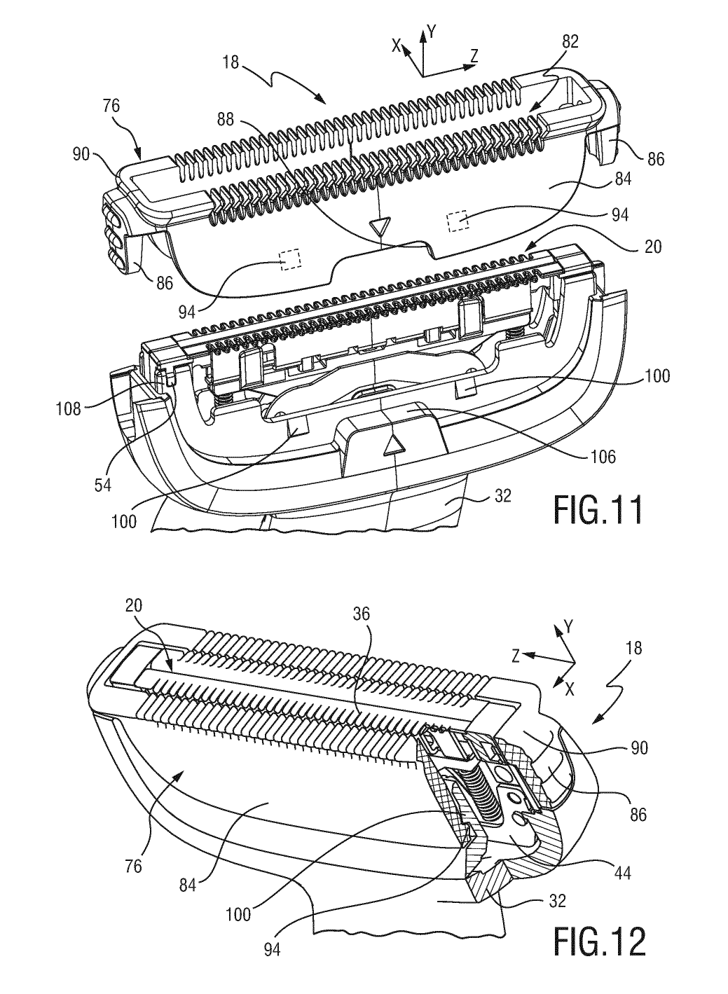

FIG. 4 shows a partial cross-sectional lateral side view of a blade set in accordance with FIGS. 2 and 3 along the line IV-IV in FIG. 3;

FIG. 5 shows a perspective view of a stationary blade and a cutter blade of the blade set, the stationary blade and the cutter blade shown in an exploded state;

FIG. 6 shows a perspective view of an embodiment of a cutting head comprising a blade set and a skin protector attached to the cutting head, wherein a housing portion is removed for illustrative purposes;

FIG. 7 is a partial frontal view of the arrangement of the cutting head illustrated in FIG. 6;

FIG. 8 is a partial cross-sectional side view of the cutting head illustrated in FIGS. 6 and 7 along the line VIII-VIII in FIG. 7;

FIG. 9 is a partial cross-sectional side view of the cutting head illustrated in FIGS. 6 and 7 along the line IX-IX in FIG. 7;

FIG. 10 is a partial detailed longitudinal side view of a skin protector that is coupled to a blade set;

FIG. 11 is a partial perspective view of an embodiment of a cutting head and a skin protector that can be attached to the cutting head, wherein the skin protector is shown in FIG. 11 in a detached state; and

FIG. 12 is another perspective view of the arrangement of the cutting head shown in FIG. 11 in an alternative orientation, wherein the skin protector is shown in the attached state and wherein a partial sectional view of the cutting head is illustrated.

### DETAILED DESCRIPTION OF EMBODIMENTS

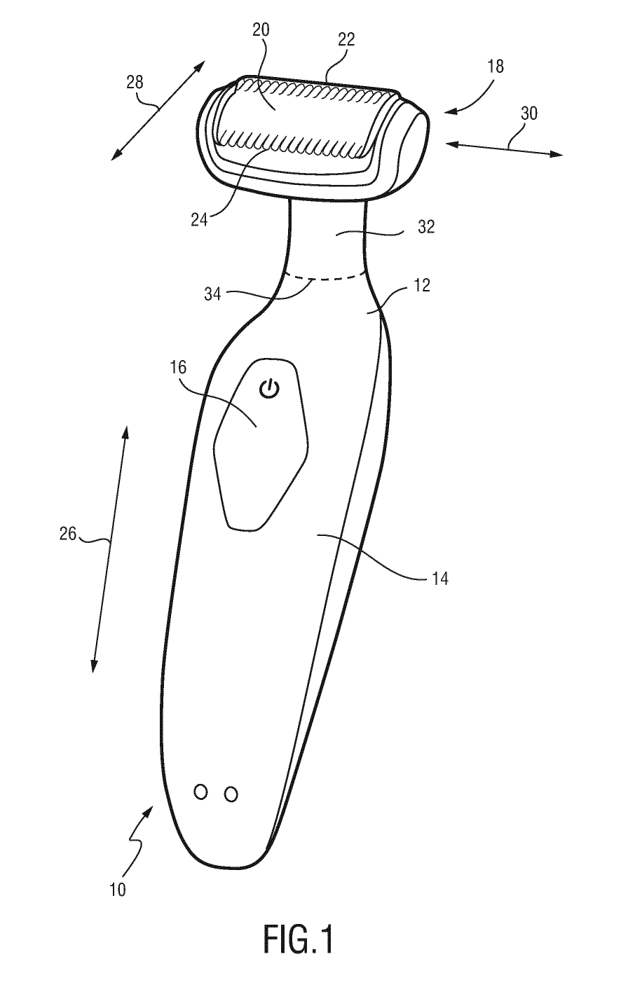

FIG. 1 schematically illustrates, in a simplified perspective view, an exemplary embodiment of a hair cutting appliance 10, particularly a body grooming appliance 10. As indicated above, the hair cutting appliance 10 may also be referred to as total body grooming appliance. The hair cutting appliance 10 is therefore not primarily intended for cutting facial hair and/or head hair. Rather, the hair cutting appliance 10 is particularly suited for cutting hair in sensitive body regions, such as intimate regions, genital regions, underarm regions, etc.

The hair cutting appliance 10 comprises an elongated housing 12. The housing 12 comprises a first end and a second end that is opposite from the first end. The second end of the housing 12 may also be referred to as handle end. Generally, the housing 12 may comprise a handle portion 14 where a user may grasp the housing 12. Generally, the housing 12 may be formed in a tubular or shaft-like manner. Furthermore, the housing 12 may be at least slightly curved or banana-shaped in its longitudinal elongated extension.

The housing 12 may further comprise operator controls 16, for instance on/off buttons, etc. At the first end of the housing 12, a cutting head 18 may be provided. The first end of the housing 12 may be therefore also referred to as neck portion. As indicated in FIG. 1, the cutting head 18 may comprise a blade set 20. The blade set 20 may define at least one toothed leading edge 22, 24. In FIG. 1, the blade set 20 defines a first toothed leading edge 22 and a second toothed leading edge 24 that is facing away from the first toothed leading edge 22.

For the purpose of cutting hair, a user may grasp the housing 12 of the hair cutting appliance 10 at the handle portion 14 and move the cutting head 18 through hair in a moving direction indicated by reference numeral 28. An ideal moving direction 28 may be generally perpendicular to a lateral direction (indicated by reference numeral 30) which may also be referred to as direction of the cutting motion of the blade set 20. A housing region of the cutting head 18 is indicated in FIG. 1 by reference numeral 32. Furthermore, a dashed line indicated by reference numeral 34 illustrates an attachment interface 34 where the cutting head 18 may be attached to the housing 12. In some embodiments, the cutting head 18 may be releasably attached to the housing 12. However, in alternative embodiments, the cutting head 18 may be permanently and fixedly attached to the housing 12. Consequently, in these embodiments no attachment interface 34 needs to be provided.

In FIG. 1, a main direction of the longitudinal/elongated extension of the housing 12 is indicated by reference numeral 26. The housing 12 may be at least slightly inclined and/or curved. As a consequence, the cutting head 18 and the blade set 20 may be at least slightly inclined with respect to a plane that is perpendicular to the elongation direction 26. Considering that the blade set 20 may define a first toothed leading edge 22 and a second toothed leading edge 24, the user or operator of the hair cutting appliance 10 may therefore operate the hair cutting appliance 10 in at least two distinct operation orientations. This may further facilitate reaching remote and hard-to-reach skin areas.

The housing 12 may further house a driving mechanism for the blade set 20. The driving mechanism (not shown in FIG. 1) may comprise an electric motor and a force transmission unit that may couple the motor and the blade set 20. Furthermore, an internal control unit may be provided. The hair cutting appliance 10 may be battery powered and/or mains-operated/line-powered. Consequently, at least in some embodiments, the housing 12 may further house a battery unit. Preferably, the hair cutting appliance 10 is designed in a water-proof fashion. This may include that the user may operate the hair cutting appliance 10 in a basically wet environment, for instance, in a bath tube or a shower.

For ease of reference, coordinate systems are indicated in several drawings herein. By way of example, a Cartesian (right-hand) coordinate system X-Y-Z is indicated in FIG. 2. An axis X of the respective coordinate system extends in a generally longitudinal direction that is generally associated with length, for the purpose of this disclosure. An axis Y of the coordinate system extends in a height (or vertical) direction which may be referred to for illustrative purposes, at least in some embodiments, as a generally vertical direction. An axis Z of the coordinate system extends in a lateral (or transverse) direction associated with width, for the purpose of this disclosure. It goes without saying that an association of the coordinate system X-Y-Z to characteristic features and/or embodiments of the hair cutting appliance 10 is primarily provided for illustrative purposes and shall not be construed in a limiting way. It should be understood that those skilled in the art may readily convert and/or transfer the coordinate system provided herein when being confronted with alternative embodiments, respective figures and illustrations including different orientations. It is further worth mentioning that, for the purpose of the present disclosure, the coordinate system X-Y-Z is generally aligned with main directions and orientations of the cutting head 18 including the blade set 20.

Further reference is made to FIGS. 2 to 5. FIG. 2 is a perspective view of a blade set 20 that may be implemented in the cutting head 18 illustrated in FIG. 1. The blade set 20 comprises a stationary blade 36 and a cutter blade 38 that may be moved with respect to each other in a cutting direction 30 which is basically parallel to the lateral direction Z to cut hair. The stationary blade 36 and the cutter blade 38 are illustrated in FIG. 5 in more detail in an exploded state.

Reference is again made to FIG. 2 and to FIG. 3. The blade set 20 further comprises a receiving frame 40 which may form a base for the stationary blade 36. The receiving frame 40 may comprise a support bow or support bracket 44 that may be coupled to the housing region 32 of the cutting head 18, refer also to FIG. 1 and to FIG. 11. The support bracket 44 may, on the one hand side, receive the stationary blade 36, directly or in a mediate fashion. The stationary blade 36 may be arranged to be fixed to the support bracket 44. Consequently, no relative motion between the support bracket 44 and the stationary blade 36 is intended when operating the blade set 20.

As can be best seen from FIGS. 3 and 4, also the cutter blade 38 may be arranged at the receiving frame 40. However, the cutter blade 38 may be received in a movable manner, particularly in a slidingly movable manner. The cutter blade 38 may be moved with respect to the stationary blade 36 in the cutting direction 30. To this end, the cutter blade 38 may be attached to a transmitter 46 that may be engaged by a driver 48 of the driving mechanism. By way of example, the driver 48 may be arranged as a pivotable driving lever that can be mounted to a pivoting axis 50 which may be attached or coupled to the housing 12 (not shown in FIG. 2). A driving pivoting motion of the driver 48 about the axis 50 is indicated in FIG. 2 by reference numeral 52. Consequently, an oscillating swiveling motion of the driver 48 can be transferred into a reciprocating slide motion of the cutter blade 38 with respect to the stationary blade 36. At an input end of the driver 48 that is opposite to an output end that is coupled to the transmitter 46, a motor, particularly an eccentric portion of an output shaft thereof, may engage the driver 48. As can be best seen in FIG. 2, the driver 48 may be at least slightly curved. As a consequence, the blade set 20 may be at least slightly inclined with respect to an orientation of an output shaft of a respective electric motor. Furthermore, at least one biasing element 42 may be arranged between the support bracket 44 and the cutter blade 38. The biasing element 42, particularly a first and a second biasing element 42 may actually urge the cutter blade 38 into contact with the stationary blade 36 to improve the cutting performance. Furthermore, the biasing element 42 may apply a reset force to the cutter blade 38 and, furthermore, cushion or attenuate the movement of the cutter blade 38. This may have a positive impact on the cutting performance and on the running noise of the blade set 20.

At lateral ends of the blade set 20, lateral connectors 56 may be provided that connect the support bracket 44 and the stationary blade 36. The first toothed leading edge 22 and the second toothed leading edge 24 of the blade set 20 may generally extend in the lateral direction Z. The first toothed leading edge 22 and the second toothed leading edge 24 may be spaced from each other in the longitudinal direction X.

As can be best seen from FIG. 4, the stationary blade 36 and the cutter blade 38 are stacked in the vertical direction or height direction Y. A front face of the stationary blade 36 is indicated in FIG. 3 by reference numeral 58. The front face 58 is the side or surface of the stationary blade 36 that is typically facing the skin when the blade set 20 is in operation. A rear face which is typically facing away from the front face 58 is indicated in FIG. 3 by reference numeral 60. The cutter blade 38 contacts the stationary blade 36 at the rear face 60 thereof.

As can be further seen from FIG. 4, respective portions of the stationary blade 36 that are associated with the first toothed leading edge 22 and the second toothed leading edge 24 may be at least slightly inclined and/or curved. Hence, the front face 58 and the rear face 60 do not necessarily have to be perfectly parallel to each other and/or to a plane that is defined by the longitudinal direction X and the lateral direction Z. However, it may be assumed that the front face 58 and the rear face 60 are substantially parallel to the aforementioned plane X-Z.

With particular reference to FIG. 4 and to FIG. 5, an exemplary embodiment of the blade set 20 is further detailed. The toothed leading edges 22, 24 of the blade set 20 may be formed by a series of teeth 62 of the stationary blade and a corresponding series of teeth 64 of the cutter blade. The teeth 62, 64 may basically extend in the longitudinal direction X. A row or series of teeth 62, 64 may basically extend in the lateral direction Z and form a corresponding leading edge 22, 24. Between the teeth 62, 64, respective tooth spaces or slots may be provided. Hairs may enter the slots and then be cut due to the relative motion of the cutter blade 38 with respect to the stationary blade 36. Tips of the tooth 62 of the stationary blade 36 are indicated by reference numeral 66 in FIGS. 3 and 4. Tips of the teeth 64 of the cutter blade 38 are indicated in FIGS. 3 and 4 by reference numeral 72. Both the teeth 62 of the stationary blade 36 and the teeth 64 of the cutter blade 38 may comprise, at least at their lateral sides, cutting edges that are facing each other and may come into contact blade to cut hair in a scissoring or shearing action when the cutter blade 38 is moved with respect to the stationary blade 36.

As can be further seen from FIGS. 4 and 5, the cutter blade 38 may comprise a basically U-shaped frame body forming a guide or slide slot 68. At the ends of the U-shaped profile, toothed portions may be provided that form the leading edges 22, 24 with the respective teeth 62 of the stationary blade 36. Generally, the cutter blade 38 may be obtained from a sheet metal blank that may be formed and processed accordingly.

The stationary blade 36 may be composed of two portions that may be shaped and connected or bonded in a wing-like fashion. Each of the components may eventually form the teeth 62 of one of the first toothed leading edge 22 and the second toothed leading edge 24, respectively. Each of the wing-shaped components may comprise a basically L-shaped section. Both components may be adequately attached to each other, for instance, via bonding, welding, etc. Consequently, the stationary blade 36 may comprise a basically T-shaped profile that extends in the lateral direction Z. A stem of the T-shaped profile may define a guide support 70 that is arranged to cooperate with the guide or slide slot 68 of the cutter blade 38. In the assembled state, the guide support 70 may be inserted in the slide slot 68. Consequently, the stationary blade 36 may provide a protruding guide for the cutter blade 38 that engages a corresponding slot thereof. The cutter blade 38 may be moved with respect to the stationary blade 36 in a reciprocating fashion in the lateral direction Z. A guide support in the longitudinal direction X and the vertical direction Y is provided by the stationary blade 36. The biasing elements 42 may urge the cutter blade 38 against the stationary blade 36 into abutment. Consequently, the longitudinal and the vertical position of the cutter blade 38 may be sufficiently defined.

Reference is again made to FIGS. 2 and 3. As can be best seen from FIG. 3, the blade set 20 is basically symmetrically shaped with respect to a central plane that is parallel to the longitudinal direction X and the vertical direction Y. However, it is preferred that the blade set 20 is always attached to the cutting head 18 (FIG. 1) in a defined orientation. Particularly, a so-called back-to-front mounting of the blade set 20 shall be avoided. It is therefore preferred at least in some embodiments to provide the blade set 20, particularly the receiving frame 40 thereof, with at least one engagement element 54 that ensures that the blade set 20 can be mounted to the cutting head 18 only in the desired orientation. By way of example, the lateral connectors 56 may be provided with respective features. As can be seen in FIGS. 2 and 3, an exemplary engagement element 54 may comprise an engagement tab, for instance, while other shapes are also possible. Generally, the engagement tab 54 may be arranged as a protrusion or recess at the receiving frame 40, particularly the lateral connector 56 thereof. The engagement element 54 may be arranged to engage a corresponding mating engagement element 108 provided at the housing region 32, refer also to FIG. 11.

Further reference is made to FIGS. 6 to 12. As can be seen from FIG. 6, a skin guard or skin protector 76 may be attached to the cutting head 18, particularly to the housing region 32 thereof. The skin protector 76 can be made from resilient material, particularly from plastic material. Preferably, the skin protector 76 is an integrally formed part. The skin protector 76 may be releasably attachable to the cutting head 18. In the alternative, the skin protector 76 may be permanently fixedly attached to the cutting head 18. As a consequence, the skin protector 76 may be provided as an add-on part or an integrated part of the cutting head 18. The skin protector 76 may comprise at least one row of guide tabs 78. Preferably, the skin protector 76 comprises a first row of guide tabs 78 associated with the first toothed leading edge 22 and a second row of guide tabs 78 associated with the second toothed leading edge 24. As can be best seen from FIG. 7 and FIG. 10, the guide tabs 78 are preferably aligned with the teeth 62 of the stationary blade 36, particularly in the longitudinal direction Z. As a consequence, the guide tabs 78 may act as longitudinal extensions of the teeth 62 and prepare the skin of the to-be-shaved skin area before the respective skin portion comes into contact with the blade set 20.

As can be further seen from FIG. 6, the skin protector 76 may comprise a frame body 80, preferably a closed frame body 80 that surrounds a blade opening 82 (refer also to FIG. 11) in which the blade set 20, particularly the stationary blade 36 thereof, may be arranged in the mounted state of the skin protector 76. The frame body 80 may further comprise two base lugs 84 that are spaced in the longitudinal direction X and generally extend in the lateral direction Z and the vertical direction Y. Furthermore, the frame body 80 may comprise two side lugs 86 that are spaced in the lateral direction Z and basically extend in the lateral direction X and the vertical direction Y. The side lugs 86 may further comprise handling features, particularly handling ridges or indentations that can be easily grabbed or grasped by an operator's hand. Furthermore, one of the two base lugs 84 may be provided with an alignment or positioning feature, particularly a positioning recess 88, that is arranged to engage a corresponding alignment feature, particularly an alignment protrusion 106, at the housing region 32, refer particularly to FIG. 11. As can be best seen from FIG. 13, the opposite base lug 84 is preferably not provided with a respective positioning recess 88. As a consequence, the skin protector 76 can be mounted to the housing region 32 only in a single desired orientation. Mounting failures can be avoided.

In the alternative or in addition, the base lugs 84 may comprise handling features, particularly ridges, indentations, etc. In the alternative or in addition, the side lugs 86 may be provided with an alignment or positioning feature that is arranged to engage a respective alignment feature at the housing region 32.

The frame body 80 of the skin protector 76 further comprises support brackets 90 that basically connect the base lugs 84 with their neighboring side lugs 86. At a frontal end of the base lugs 84, the respective guide tabs 78 of the skin protector 76 are provided. A front face of the skin protector 76 that is defined by respective frontal end faces of the guide tabs 78 is indicated in FIG. 6 by reference numeral 92, refer also to FIG. 8 and to FIG. 9.

Further reference is made to FIG. 8 and to FIG. 9, each of which illustrating an enlarged partial cross-sectional view of the cutting head 18. FIG. 8 shows a central cross-sectional view taken along the line VIII-VIII in FIG. 7. FIG. 9 shows a cross-sectional view taken along the IX-IX in FIG. 7. It is preferred that the blade set 20, particularly the stationary blade 36 thereof at least slightly protrudes beyond the front face 92 of the skin protector 76. By way of example, the front face 58 of the stationary blade 36 may be offset from the front face 92 of the skin protector 76 by an offset dimension lₒ. In other words, the front face 92 may be rearwardly offset from the front face 58 of the stationary blade 36. Generally, the front face 58 of the stationary blade 36 may comprise a basically even and planar shape. Generally, the front face 92 of the skin protector 76 may comprise a basically even and planar shape. However, as can be also seen from FIGS. 8 and 9, the respective front faces 58, 92 do not necessarily have to be perfectly planar and parallel to each other. This may particularly apply to opposite sections of the front faces 58, 92 that are associated with the toothed leading edges 22, 24, respectively.

Preferably, the offset dimension lₒ is in the range of about (e.g. slightly beyond) 0.0 mm to about 0.5 mm. More preferably, the offset dimension is in the range of about 0.15 mm to about 0.5 mm. For ease of definition, the offset dimension lₒ may be determined at (or a position adjacent to) a transition between the stationary blade 36 and the skin protector 78 close to the tips 66 of the teeth 62 of the stationary blade 36. Preferably, a vertical offset is determined which may be regarded as offset dimension lₒ. However, further methods for determining the offset dimension lₒ may be envisage, e.g. by determining a vertical offset between uppermost points of the front face 58 of the stationary blade 36 and the front face 92 of the skin protector 78.

As can be further seen from FIG. 8, the guide tabs 78 may comprise a basically triangular shape. The guide tabs 78 may be delimited by the front face 92 and an inclined end surface 98 basically facing away from the front face 92. The front face 92 and the inclined end surface 98 may merge into each other at an end tip 96 of the guide tabs 78. An angle of inclination a between the inclined end surface 98 and the front face 92 may be in the range of about 30° to about 60° (degrees), preferably in the range of about 40° to about 50°. This may further increase the cutting performance and the skin protecting performance of the cutting head 18 that is fitted with the skin protector 76.

A longitudinal extension lₜ of the guide tabs 78 is indicated in FIG. 9. Preferably, the longitudinal extension lₜ is in the range of about 0.0 mm to about 5.0 mm. More preferably, the longitudinal extension lₜ is in the range of about 2.0 mm to about 4.0 mm, even more preferably in the range of about 2.5 mm to about 3.5 mm, yet more preferably, the longitudinal extension lₜ is about 3.0 mm. The above ranges and value may be regarded as a beneficial trade-off between the contour following capability of the cutting head 18 and the skin protecting performance as well as the hair cutting performance of the cutting head 18.

As can be further seen from FIG. 9, the at least one engagement element 54, e.g. an engagement tab, that is associated with the blade set 20 may engage in the mounted state a corresponding positioning element 108, e.g. a positioning recess, that is provided at the housing region 32.

Further reference is made to FIGS. 10, 11 and 12. As can be best seen from FIGS. 11 and 12, the base lugs 84 may further comprise at least one engagement element or snap-on element 94. To this end, the base lugs 84 may be defined such that the snap-on element 94 may be urged into contact with at least one corresponding mating engagement element 100 that is provided at the housing region 32 of the cutting head 18. Consequently, a snap-on or clip-on connection between the skin protector 76 and the housing region 32 may be achieved. Preferably, the skin protector 76 is releasably attachable to the housing region 32. The snap-on element 94 is basically hidden in FIGS. 10 and 11 and therefore indicated by dashed lines. Alternatively, or in addition, the side lugs 86 may be provided with respective snap-on features that may engage corresponding features at a receiving portion for the side lugs at of the housing region 32. Generally, the snap-on elements may be urged into contact with their counterparts such that a tight fit and/or force fit mounting of the skin protector 74 at the cutting head 18 may be achieved.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A cutting head for a hair cutting appliance, particularly an electrically operated body grooming appliance, the cutting head (18) comprising:
a blade set comprising a stationary blade and a cutter blade, the stationary blade and the cutter blade comprising at least one toothed leading edge jointly defined by respective teeth of the stationary blade, the teeth of the stationary blade and the cutter blade basically extending in a longitudinal direction (X),
a skin protector comprising a plurality of guide tabs that are aligned with the teeth of the stationary blade,
wherein the stationary blade further comprises a front face, particularly at the teeth thereof, the front face being arranged to face a user's skin, when in operation,
wherein the cutter blade is at least partially arranged at a rear face of the stationary blade facing away from the front face, particularly at the teeth of the stationary blade,
wherein the cutter blade can be reciprocally moved with respect to the stationary blade to cut hair,
wherein the guide tabs of the skin protector are arranged adjacent to longitudinal tips of the teeth of the stationary blade in a longitudinally displaced position,
wherein the skin protector defines a front face, particularly at the guide tabs thereof, the front face being arranged to face a user's skin, when in operation,
wherein the front face of the skin protector is at least partially rearwardly offset from the front face of the stationary blade, and
wherein the skin protector comprises at least one snap-on element that is adapted to a corresponding engagement portion of a housing region of the cutting head.

2. The cutting head as claimed in claim 1, wherein the skin protector comprises at least one row of guide tabs extending from a frame body, wherein the guide tabs of the row alternate with spacing slots arranged therebetween that are aligned with respective tooth spaces arranged between the teeth of the stationary blade.

3. The cutting head as claimed in claim 1, wherein the number of the teeth at the stationary blade is equal to or greater than the number of the guide tabs at the skin protector, wherein a ratio of the number of the teeth of the stationary blade to the number of the guide tabs at the skin protector is preferably an integer number.

4. The cutting head as claimed in claim 1, wherein the blade set is a dual sided blade set, wherein the stationary blade and the cutter blade define a first toothed leading edge and a second toothed leading edge that is facing away from the first leading edge, wherein the first toothed leading edge and the second toothed leading edge are longitudinally spaced from each other, and wherein the skin protector comprises a first arrangement of guide tabs associated with the first toothed leading edge and a second arrangement of guide tabs associated with the second toothed leading edge.

5. The cutting head as claimed claim 4, wherein the teeth of the stationary blade at the first toothed leading edge and the teeth of the stationary blade of the second toothed leading edge are laterally offset from each other, and wherein the first arrangement of guide tabs and the second arrangement of guide tabs are offset from each other in a similar fashion.

6. The cutting head as claimed in claim 1, wherein the skin protector is arranged as an attachment skin protector that is releasably attachable to the cutting head, wherein the skin protector is preferably an integrally formed part made from resilient material, particularly from plastic material.

7. The cutting head as claimed in claim 1, wherein a set of skin protectors is provided that are releasably attachable to the cutting head and that differ in the number and shape of their guide tabs.

8. The cutting head as claimed in claim 1, wherein the skin protector and the cutting head comprise at least one positioning element and at least one corresponding engagement element that are configured to define a mounting position of the skin protector at the cutting head such that reversed mounting of the skin protector can be prevented.

9. The cutting head as claimed in claim 1, wherein the blade set and a housing region of the cutting head comprise at least one positioning element and at least one corresponding engagement element that are configured to define a mounting position for the blade set at the cutting head such that reversed mounting of the blade set can be prevented.

10. The cutting head as claimed in claim 1, wherein the guide tabs of the skin protector comprise a longitudinal extension (lₜ), particularly at the front face of the skin protector, that is less than 5.0 mm, preferably about 3.0 mm.

11. The cutting head as claimed in claim 1, wherein the front face of the skin protector is rearwardly offset from the front face the stationary blade by an offset dimension (lₒ) in the range of about 0.0 mm to about 0.5 mm, preferably in the range of about 0.35 mm to about 0.5 mm.

12. The cutting head as claimed in claim 1, wherein the guide tabs of the skin protector comprise an end tip at their longitudinal end, wherein the end tip connects the front face and a respective inclined end surface of the guide tabs, wherein an angle of inclination (α) between the front face and the inclined end surface of the guide tabs is in the range of about 30° to 60°, preferably in the range of about 40° to 50°, more preferably about 45°.

13. The cutting head as claimed in claim 1, wherein the skin protector comprises a loop-like closed structure formed by a frame body, wherein the closed structure surrounds a blade opening, wherein the blade set is arranged in the mounted state in the blade openings, wherein the frame body comprises two opposite, substantially laterally and vertically extending base lugs at longitudinal ends and two opposite, substantially longitudinally and vertically extending side lugs at lateral ends, and wherein at least one of the base lugs or of the side lugs comprises a mounting alignment feature, particularly a recess or a protrusion.

14. The cutting head as claimed in claim 13, wherein the side lugs are coupled to basically U-shaped lateral bracket portions arranged adjacent to lateral ends of the blade set, and wherein at least one of the base lugs and the side lugs comprise snap-on features and includes at least one engagement element for engaging a mating engagement element at a housing region of the cutting head.

15. A hair cutting appliance particularly an electrically operated body grooming appliance, the hair cutting appliance comprising a cutting head and a skin protector as claimed in claim 1.
